(19) United States
(12) Patent Application Publication
(10) Pub. No.: US 2005/0259642 A1
(43) Pub. Date: Nov. 24, 2005

(54) Blade server for auto-assigning communication addresses

(75) Inventors: Shih-Yun Yang, Taoyuan County (TW); Ching-Chih Shih, Taoyuan County (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Quanta Computer Inc

(21) Appl. No.: 11/081,971

(22) Filed: Mar. 16, 2005

(30) Foreign Application Priority Data
May 18, 2004 (TW) 93113929

(51) Int. Cl. H04Q 11/00

(52) U.S. Cl. 370/376

(57) ABSTRACT

A blade server system for auto-assigning communication addresses. The Blade server system comprises a board and a slot module. The board has a plurality of slots, and each of the slots has a unique slot ID. When the slot module is inserted in one of the slots, the slot module generates a communication address according to the slot ID of an occupied slot, and then transmits the communication address to other slot modules inserted in other slots. Hence, other slot modules can communicate with the slot module via the communication address.

### BACKGROUND

The invention relates to a blade server for auto-assigning communication addresses, and more particularly to a blade server for auto-assigning communication addresses, which data exchanged on the Inter Integrated Circuit (I²C) bus with multiple function modules.

In a conventional server room, more several servers are deposed in multiple chassis to provide services, consuming excessive space. Thus, a trend is to integrate the servers into one chassis to reduce multiple required space. An example of this arrangement is a blade server.

FIG. 1 shows a block diagram of a conventional blade server system. The conventional blade server system 100 comprises a board 1 and a slot module 21. The board 1 comprises a plurality of slots (11, 12, 13, 14) and a bus 10. The slot module 21 requires a unique communication address to communicate through the bus 10 with other slot modules. Generally, a communication address of the slot module 21 is predefined according to its own capability. For example, if the slot module 21 acts as a server, a communication address between 21H˜30H may be assigned thereto. Similarly, if the slot module 21 acts as a storage server, a communication address between 00H˜20H may be assigned thereto. Thus, according to the fixed communication address, the slot module 21 can communicate with the other modules via the bus 10 after being inserted in one of the slots.

The number of the communication addresses, however, is limited, and the board 1 allows two and more slot modules having the same capability, i.e., there may be duplicate communication addresses in the blade server system after a hot swap. For example, if a sever slot module with a communication address 21H is added to the board 1, when another server slot module in one of the slots has same communication address 21H, a communication address conflict occurs.

### SUMMARY

An aspect of the invention provides a blade server system for auto-assigning communication addresses, comprising a board and a slot module. The board has a plurality of slots, and each slot has a unique slot identification(ID). When the slot module is inserted in one of the slots, the slot module generates a communication address according to the unique slot ID of an occupied slot, and then transmits the communication address to other slot modules inserted in other slots. Hence, other slot modules can communicate with the slot module via the designated communication address.

Another aspect of the invention provides a slot module employed in a blade server system. The blade server system at least comprises a board having a plurality of slots and a bus, and the slot module can be inserted in one of the slots. The slot module comprises a management device for reading a slot ID of an occupied slot, to accordingly generate a communication address and transmit the communication address to other slot modules via the bus.

Furthermore, another aspect of the invention provides a control method for controlling a slot module of a blade server system. The Blade server system at lease comprises a board with a plurality of slots and a bus, and the control method comprises the steps of detecting whether the slot module is inserted to one of the slots, reading a slot ID of an inserted slot, generating a communication address according to the slot ID, and transmitting the communication address to other slot modules.

### BRIEF DESCRIPTION OF THE DRAWINGS

An embodiment of the invention will become apparent by referring to the following detailed description and accompanying drawings, wherein:

FIG. 1 shows a block diagram of a conventional blade server system;

FIG. 2 shows a block diagram of a blade server system; and

FIG. 3 is a flowchart of the control method of the invention.

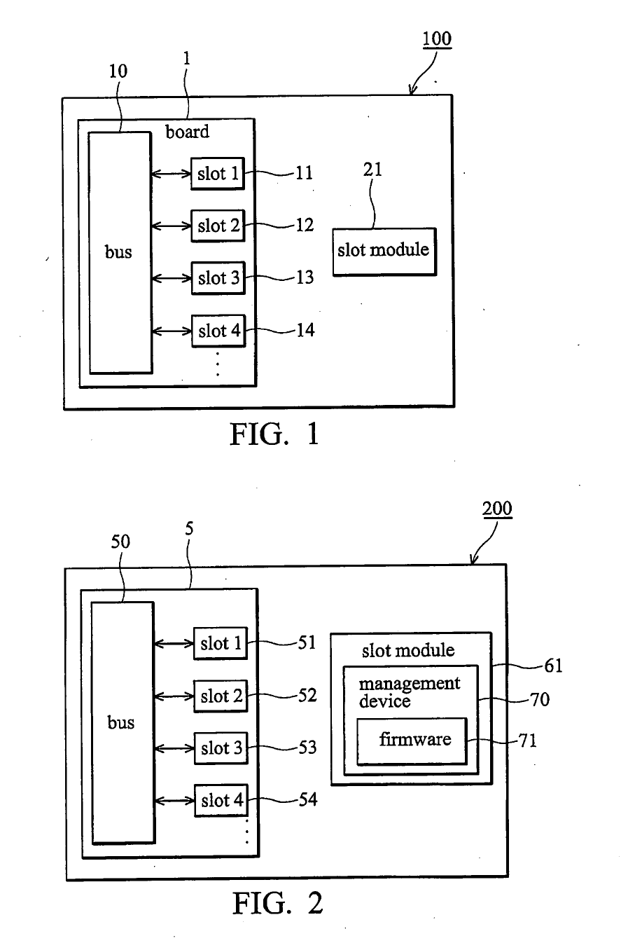

### DETAILED DESCRIPTION

An embodiment of the invention provides a blade server system for auto-assigning communication addresses, to eliminate communication address conflicts. That is, the invention provides a mechanism with auto-assigning communication address to exchange data between modules within blade server system.

FIG. 2 shows a block diagram of a blade server system. The blade server system 200 comprises a board 5 and a slot module 61. The board 5 comprises a plurality of slots 51˜54 and a bus 50, and each slot has a unique slot ID. The bus 50 is coupled to each of the slots. The slot module 61 comprises a management device 70. When the slot module 61 is inserted into slot 51, the management device 70 generates a communication address according to the slot ID of the slot 51, and transmits the communication address to the other slot modules. Additionally, the system 200 can employ any type of bus system. For example, the bus 50 is an I²C bus.

The management device 70 further comprises a firmware 71 that stores a communication address identification list. When receiving the slot ID of the slot 51, the slot module 61 compares the slot ID with the communication address identification list to determining which communication address the slot module 61 to generate.

Thus, when the slot module 61 is inserted into different slots, the management device 70 is able to generate another unique communication address according to the unique slot ID. Hence, even if two or more slot modules having the same capability are inserted in other slots, each slot module still generates unique communication address, thus eliminating communication address conflicts.

After generating the communication address port signal, the management device 70 transmits the communication address to other slot modules. For example, the management device 70 broadcasts the communication address at a predetermined time interval to notify other slot modules. Hence, other slot modules can communicate with the slot module 61 via the communication address.

Additionally, the slot IDs of the slots can be determined by binary digits. For example, if the board 5 has eight slots, three analog signals can be provided to three pins of each slot to serve as a binary logic signals or a slot ID, such that a high-potential analog signal is referred to as logic “1”, and a low-potential analog signal is referred to as logic “0”. Thus, the binary logic signal composed of the analog signals can be varied from “000” to “111”, i.e., each slot can receive one unique binary logic signal between “000” to “111”. Hence, when being inserted in one of the slots, the slot module 61 can receive either a binary logic signal or an unique slot ID, thereby generating a corresponding unique communication address.

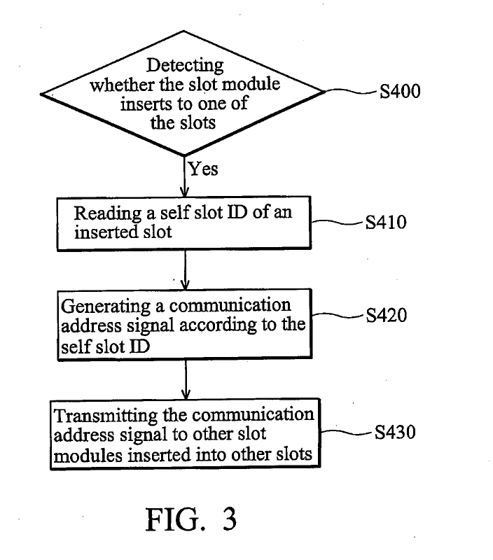

FIG. 3 is a flowchart of the control method of the invention. Initially, in step S400, the management device 70 detects whether a slot module 61 is inserted in one of the slots. Step S410 follows, and the management device 70 reads a slot ID of a slot when the slot module 61 is inserted therein, step S420 follows, and the management device 70 generates a communication address according to the slot ID. Finally, in step s430, the management device 70 transmits the communication address to other slot modules.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A blade server system for auto-assigning communication addresses, comprising:
a board having a plurality of slots, each slot having a unique slot identification(ID); and
a slot module, which can be inserted in one of the slots to accordingly generate a communication address according to a slot ID of the inserted slot.

2. The Blade server system of claim 1, wherein, the system further comprises:
a bus disposed on the board and coupled to the slots;
wherein, the communication address is transmitted and broadcasted via the bus.

3. The Blade server system of claim 2, the slot module further comprises a management device, wherein when the slot module is inserted to the inserted slot, the management device accordingly generates the communication address according to the slot ID and transmits the communication address.

4. The Blade server system of claim 3, wherein the management device at least comprises a firmware for storing a communication address identification list;
wherein the management device compares the slot ID with the communication address identification list to generate the communication address.

5. The Blade server system of claim 2, wherein the bus is I²C bus.

6. A slot module employed in used for a blade server system, wherein the Blade server system at least comprises a board having a plurality of slots, and the slot module can be inserted in one of the slots, the slot module comprising:
a management device, for reading a slot ID of an inserted slot, and generating a communication address.

7. The slot module of claim 6, wherein the Blade server system further comprises a bus coupled to the slots, and the management device transmits the communication address to other slot modules inserted in other slots via the bus.

8. The slot module of claim 6, wherein the management device further comprises a firmware for storing a communication address identification list.

9. The slot module of claim 8, wherein the management device compares the slot ID with the communication address identification list to generate the communication address.

10. The slot module of claim 7, wherein, the management device transmits the communication address by broadcasting.

11. The slot module of claim 7, wherein the bus is a I²C bus.

12. A control method, for controlling a slot module of a blade server system, wherein the blade server system at lease comprises a board having a plurality of slots, the control method comprising following steps:
detecting whether the slot module is inserted in one of the slots;
reading a slot ID from the inserted slot;
generating a communication address according to the slot ID; and
transmitting the communication address to other slot modules inserted in other slots.

13. The control method of claim 12, wherein, after the step of reading the slot ID of the inserted slot is processed, the control method further comprises following step;
comparing the slot ID with a communication address identification list to generate the communication address.

14. The control method of claim 12, wherein the step of transmitting transmits the communication address to other slot modules by broadcasting.
